(19) United States
(12) Patent Application Publication
(10) Pub. No.: US 2012/0176562 A1
(43) Pub. Date: Jul. 12, 2012

(54) DISPLAY

(75) Inventors: MING-CHANG LEE, Tu-Cheng (TW); YONG-FENG ZHAO, Shenzhen City (CN); HONG-QI HOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/013,834

(22) Filed: Jan. 26, 2011

(30) Foreign Application Priority Data
Jan. 7, 2011 (CN) 201110003165.0

(51) Int. Cl. G02F 1/1333

(52) U.S. Cl. 349/58

(57) ABSTRACT

A display includes a first mounting member, a second mounting member, an LCD panel, and a back light module. The first mounting member includes a receiving portion to receive the LCD panel and the back light module. The second mounting member is fixed to the first mounting member to sandwich the LCD panel and the back light module between the first and second mounting members.

### BACKGROUND

1. Technical Field

The present disclosure relates to a display.

2. Description of Related Art

A display for a notebook computer or a desktop computer usually includes a frame to fix a liquid crystal display (LCD) panel and a back light module together, and then the LCD panel and the back light module together with the frame are sandwiched between a front cover and a back cover of the display. The assembly process is so much and inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a display, the display includes a first mounting member, a second mounting member, a liquid crystal display (LCD) panel, and a back light module.

FIG. 2 is an enlarged view of a circled portion II of FIG. 1.

FIG. 3 is an assembled view of the LCD panel, the back light module, and the first mounting member of FIG. 1.

FIG. 4 is an enlarged view of a circled portion IV of FIG. 3.

FIG. 5 is an assembled view of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

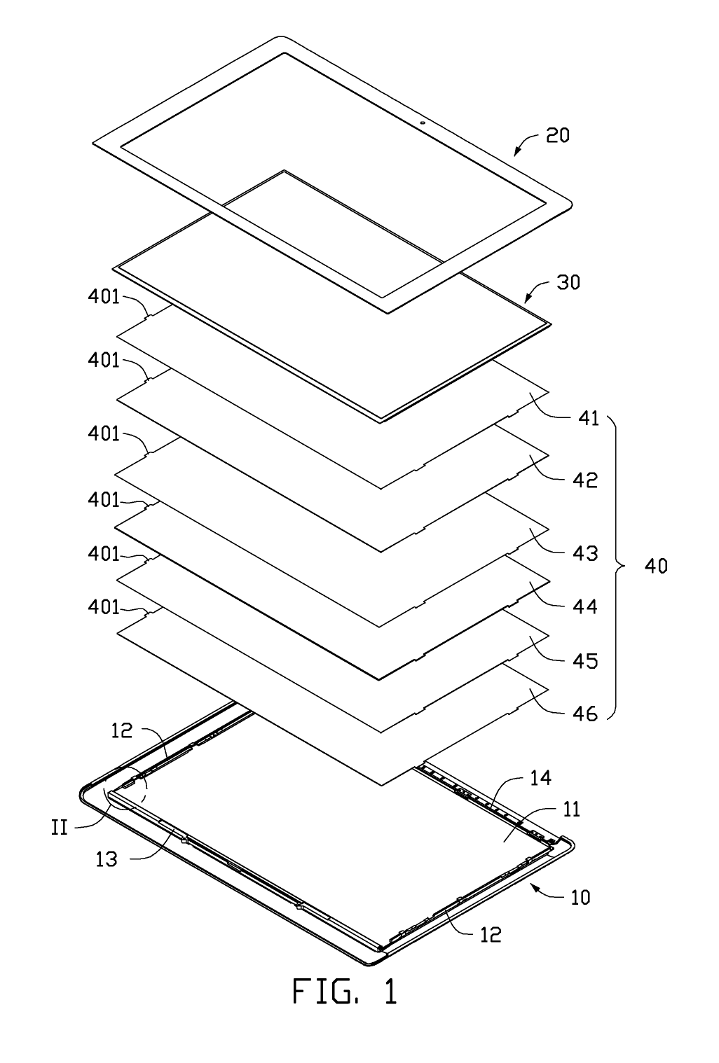

Referring to FIG. 1, an exemplary embodiment of a display includes a first mounting member 10, a second mounting member 20, and a panel module. The panel module includes a liquid crystal display (LCD) panel 30 and a back light module 40.

The first mounting member 10 is a front cover of a notebook computer in this embodiment. A receiving portion 11 is arranged on an inner surface of the first mounting member 10. Two opposite first mounting units 12, with a second mounting unit 13 connected between the first mounting units 12, and a third mounting unit 14 opposite to the second mounting unit 13 are integrally formed on the inner surface of the first mounting member 10 around the receiving portion 11.

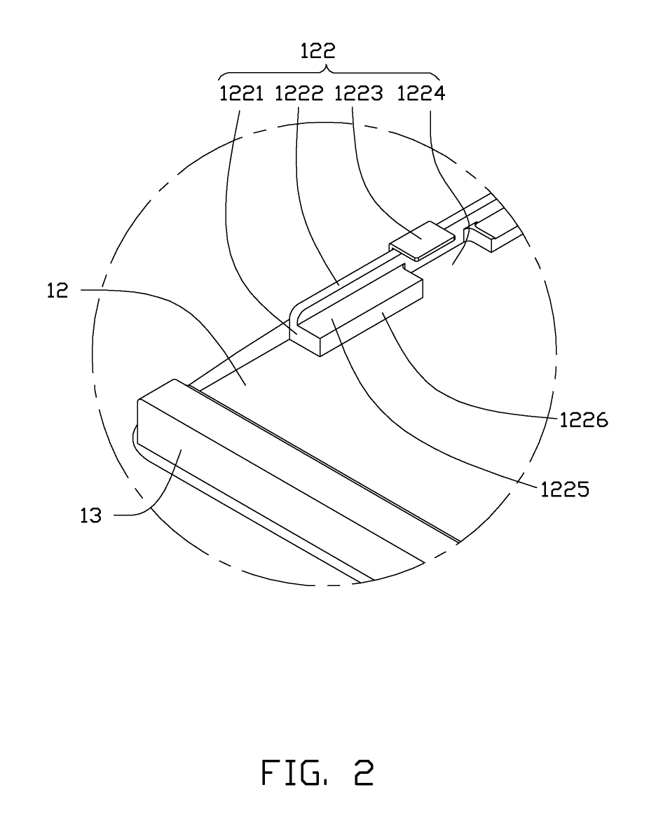

Referring to FIG. 2, each first mounting unit 12 includes a plurality of mounting portions 122. Each mounting portion 122 includes a supporting block 1221 extending from the receiving portion 11, a stop portion 1222 extending from an outer side of the supporting block 1221, and a limiting piece 1223 extending inward from a top of the stop portion 1222. A latching slot 1224 is defined in each supporting block 1221 and below the limiting piece 1223. The second mounting unit 13 is a flange extending from the inner surface of the first mounting member 10 in this embodiment. Each supporting block 1221 includes a top surface 1225 and a side surface 1226. The second mounting member 20 is a frame defining an opening in a center.

The back light module 40 includes an upper diffuser 41, an upper brightness enhancement film (BEF) 42, a lower BEF 43, a lower diffuser 44, a light guide 45, and a white reflector 46. Two spaced tabs 401 extend from each end of each of the upper diffuser 41, the upper BEF 42, the lower BEF 43, the lower diffuser 44, the light guide 45, and the white reflector 46.

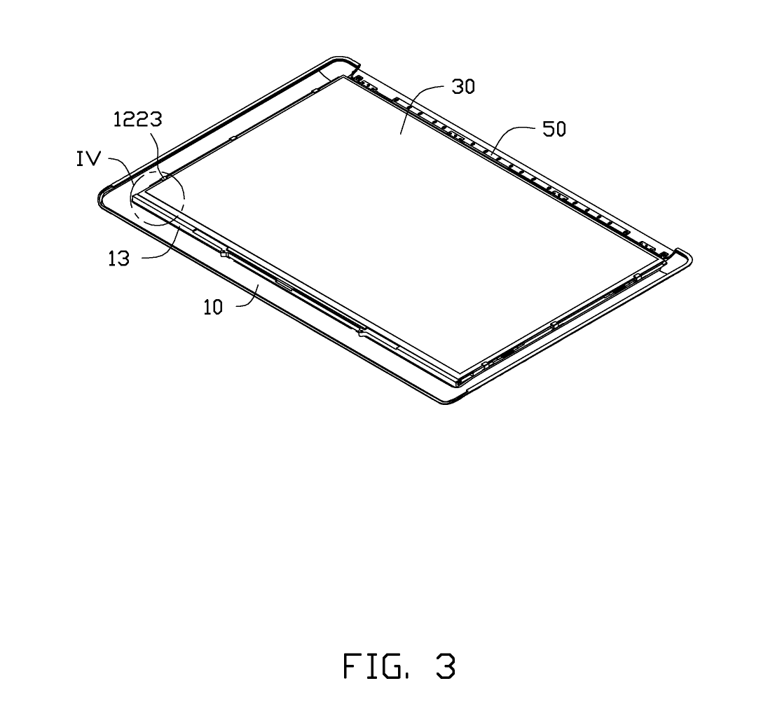

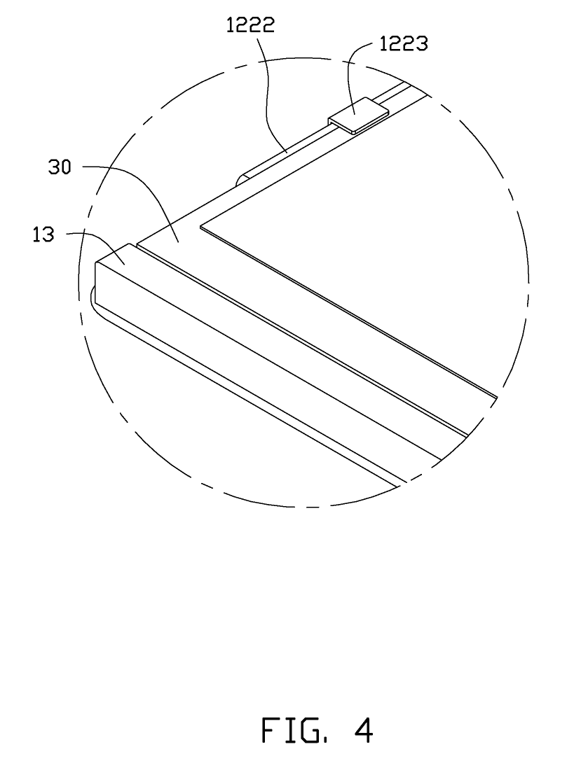

Referring to FIGS. 3 and 4, in assembly, the white reflector 46, the light guide 45, the lower diffuser 44, the lower BEF 43, the upper BEF 42, and the upper diffuser 41 are stacked in the receiving portion 11 of the first mounting member 10 in that order. The ends of the white reflector 46, the light guide 45, the lower diffuser 44, the lower BEF 43, the upper BEF 42, and the upper diffuser 41 resist against the side surfaces 1226 of the supporting blocks 1221. The tabs 401 of the white reflector 46, the light guide 45, the lower diffuser 44, the lower BEF 43, the upper BEF 42, and the upper diffuser 41 engage in the latching slots 1224 of the first mounting units 12. The LCD panel 30 is received in the receiving portion 11 of the first mounting member 10 and is located on the upper diffuser 41 of the back light module 40. Two ends of the LCD panel 30 are supported on the top surfaces 1225 of the supporting blocks 1221 and are locked under the limiting pieces 1223. The second mounting unit 12 blocks the first sides of the LCD panel 30 and the back light module 40. A fastener 50 is provided to function as the third mounting unit 14, which is fixed on the first mounting member 10 to block second sides of the LCD panel 30 and the back light module 40. In this embodiment, the fastener 50 is a bar, which is fixed on the first mounting member 10 by a plurality of screws.

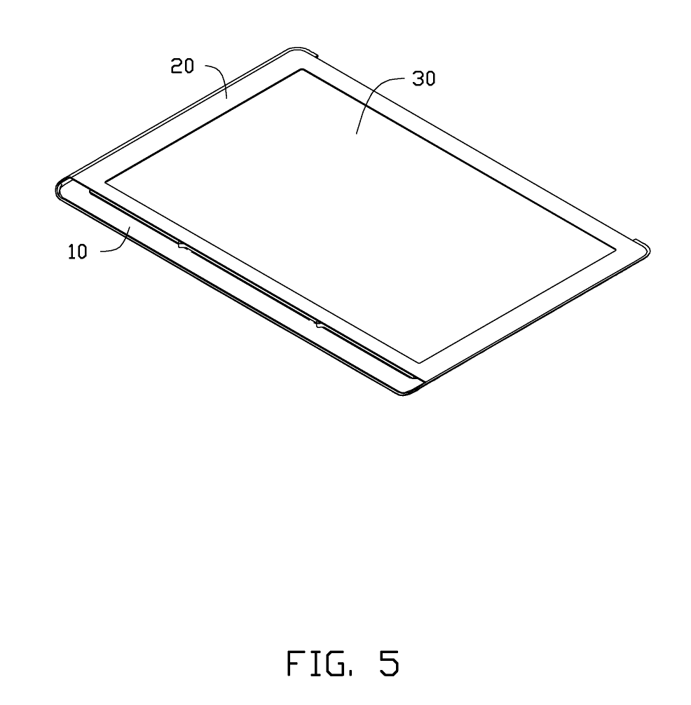

Referring to FIG. 5, the second mounting member 20 is fixed to the first mounting member 10 to sandwich the LCD panel 30 and the back light module 40 between the first mounting member 10 and the second mounting member 20.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A display comprising:
a first mounting member comprising a receiving portion on an inner surface of the first mounting member, wherein two opposite first mounting units, a second mounting unit connected between the first mounting units, and a third mounting unit opposite to the second mounting unit are integrally formed on the inner surface of the first mounting member around the receiving portion;
a second mounting member; and
a liquid crystal display (LCD) panel and a back light module received in the receiving portion of the first mounting member;
wherein the first mounting units, the second mounting unit, and the third mounting unit limit the edges of the LCD panel and the back light module, the second mounting member is fixed to the first mounting member to sandwich the LCD panel and the back light module between the first and second mounting members.

2. The display of claim 1, wherein each of the first mounting units comprises a plurality of mounting portions, each of the mounting portions comprises a supporting block, a stop portion extending up from an outer side of the supporting block, and a limiting piece extending inward from a top of the stop portion, each of the supporting blocks comprises a top surface and a side surface, two opposite ends of the back light module engage with the side surfaces of the supporting blocks, two opposite ends of the LCD panel are supported on the top surfaces of the supporting blocks and locked under the limiting pieces.

3. The display of claim 2, wherein a latching slot is defined in each supporting block and below the limiting piece, the back light module comprises a plurality of tabs, the tabs engage in the latching slots of the first mounting units.

4. The display of claim 1, wherein the second mounting unit is a flange extending from the inner surface of the first mounting member, first sides of the LCD panel and the back light module are blocked by the second mounting unit, second sides of the LCD panel and the back light module are blocked by the third mounting unit.

5. The display of claim 4, wherein the third mounting unit is a bar fixed on the first mounting member.
